(19) United States
(12) Patent Application Publication
(10) Pub. No.: US 2020/0156362 A1
(43) Pub. Date: May 21, 2020

(54) STEREOLITHOGRAPHIC APPARATUS AND STEREOLITHOGRAPHIC METHOD

(71) Applicant: Kabushiki Kaisha Toshiba, Minato-ku (JP)

(72) Inventors: Kosuke ADACHI, Yokohama (JP); Shinobu OOFUCHI, Yokohama (JP); Kodo YAMANOUCH, Yokohama (JP); Shogs SUZUMURA, Yokohama (JP); Yasuaki HADAME, Arakawa (JP); Masaomi Nakahata, Kamakura (JP); Yuichiro YAMAMOTO, Yokohama (JP)

(73) Assignee: Kabushiki Kaisha Toshiba, Minato-ku (JP)

(21) Appl. No.: 16/749,838

(22) Filed: Jan. 22, 2020

Related U.S. Application Data
(62) Division of application No. 15/508,364, filed on Mar. 2, 2017.

(30) Foreign Application Priority Data
Sep. 17, 2014 (JP) 2014-188537

(51) Int. Cl. B33Y 30/00; B33Y 10/00; B29C 64/268; B29C 64/135

(52) U.S. Cl. CPC B33Y 30/00; B29C 64/135; B29C 64/268; B33Y 10/00

(57) ABSTRACT

A stereoilithography apparatus includes a first optical system, a second optical system, an area setter and a moving mechanism. The first optical system emits a first light to a photocurable material. The second optical system emits a second light to the photocurable material such that a target area is formed in the photocurable material. The target area linearly intersects the first light in a first direction. The area setter sets a first area and a second area for at least one of the first light and the second light in the first direction at the target area. The first area and the second areas have different optical properties from each other. The moving mechanism moves the target area. The stereolithography apparatus cures the photocurable material at the target area.

### CROSS-REFERENCE TO RELATED APPLICATIONS

This application is a divisional application of and claims the benefit of priority under 35 U.S.C. § 120 from U.S. application Ser. No. 15/508,364, filed Mar. 2, 2017, which is a national stage of PCT/JP2015/054295, filed Feb. 17, 2015, which claims the benefit of priority from Japanese Patent Application No. 2014-188537, filed Sep. 17, 2014, the entire contents of each of which are incorporated herein by reference.

### FIELD

Embodiments described herein relate generally to a stereolithography apparatus and a stereolithography method.

### BACKGROUND

Conventionally, a stereolithography apparatus is known which includes a first optical system for emitting first light to a target position, a second optical system for emitting second light intersecting the first light to the target position, and a moving mechanism for moving the target position. The stereolithography apparatus manufactures an intended object by curing a photocurable material at the intersections of the first light and the second light in the target position, for example.

It is preferable to attain such a stereolithography apparatus with a novel structure which can further shorten a length of time taken for manufacturing an intended object.

A stereolithography apparatus according to an embodiment includes, for example, a first optical system, a second optical system, an area setter, and a moving mechanism. The first optical system emits a first light to a photocurable material. The second optical system emits a second light to the photocurable material such that the second light linearly intersects the first light in a first direction in the photocurable material. The area setter sets, for at least one of the first light and the second light, a first area and a second area having different optical properties from each other, at an intersection of the first light and the second light in the first direction. The moving mechanism moves the intersection of the first light and the second light. The stereolithography apparatus cures the photocurable material at the intersection of the first light and the second light.

### BRIEF DESCRIPTION OF DRAWINGS

FIG. 1 is a schematic diagram of an exemplary stereolithography apparatus according to a first embodiment;

FIG. 2 is a schematic perspective view illustrating an exemplary manufacturing method by the stereolithography apparatus according to the first embodiment;

FIG. 3 is a schematic side view illustrating the exemplary manufacturing method by the stereolithography apparatus according to the first embodiment;

FIG. 4 is a schematic side view illustrating the exemplary manufacturing method by the stereolithography apparatus according to the first embodiment, as viewed in a different direction from that in FIG. 3;

FIG. 5 is a schematic diagram of an exemplary stereolithography apparatus according to a modification of the first embodiment;

FIG. 6 is a schematic perspective view illustrating an exemplary manufacturing method by the stereolithography apparatus according to a second embodiment;

FIG. 7 a schematic side view illustrating the exemplary manufacturing method by the stereolithography apparatus according to the second embodiment; and

FIG. 8 is a schematic perspective view illustrating an exemplary manufacturing method by a stereolithography apparatus according to a third embodiment.

According to an embodiment, a stereolithography apparatus comprises a first optical system, a second optical system, an area setter and a moving mechanism. The first optical system emits a first light to a photocurable material. The second optical system emits a second light to the photocurable material such that a target area is formed in the photocurable material. The target area linearly intersects the first light in a first direction. The area setter sets a first area and a second area for at least one of the first light and the second light in the first direction at the target area. The first area and the second areas have different optical properties from each other. The moving mechanism moves the target area. The stereolithography apparatus cures the photocurable material at the target area.

### DETAILED DESCRIPTION

Hereinafter, exemplary embodiments of the present invention will be disclosed. Configurations in the embodiments described below and functions and results (effects) implemented by the configurations are merely exemplary. The present invention is achievable by other configurations than those disclosed herein. The present invention can attain at least one of a variety of effects (including derivative effects) achieved by the configurations.

The embodiments described below include same or like constituent elements. The same or like constituent elements are denoted by common reference numerals and an overlapping description thereof will be omitted. In the following detailed description, three directions, X, Y, and Z directions orthogonal to one another are defined for the sake of convenience. X and Y directions represent horizontal direction while Z direction represents vertical direction.

### First Embodiment

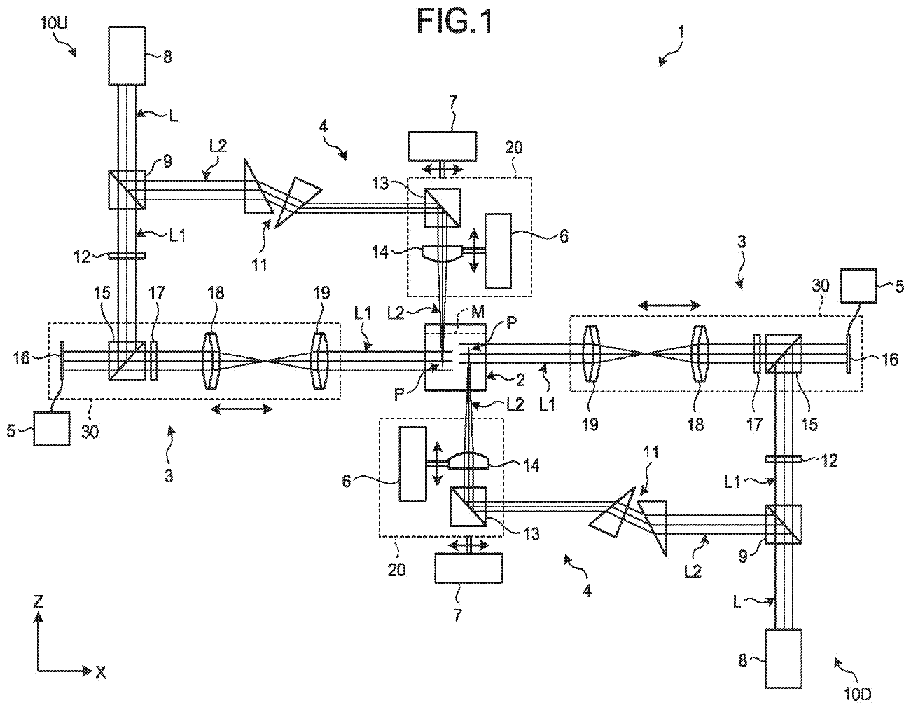

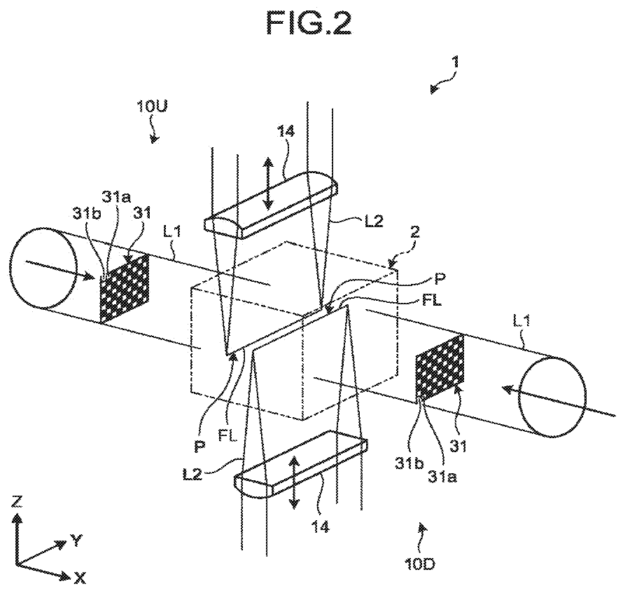

As illustrated in FIGS. 1 and 2, a stereolithography apparatus 1 includes a liquid tank 2 (container, modeling container, storage tank) and multiple stereolithography units 10U, 10D. The stereolithography unit 10U is one example of a first stereolithography unit and the stereolithography unit 10D is one example of a second stereolithography unit. In place of the two stereolithography units 10U, 10D in the present embodiment, three or more stereolithography units can be provided.

The liquid tank 2 contains, for example, a liquid photocurable material M (such as photocurable resin) inside. The liquid tank 2 has a rectangular parallelepiped box shape. The walls of the liquid tank 2 are at least partially made from a light transmissive material (such as glass) for the purpose of allowing lights L, L2 to transmit therethrough from outside the liquid tank 2 and enter the liquid tank 2 toward positions P. The material M also allows the transmission of the lights L1, L2. The liquid tank 2 includes a not-shown platform for supporting a manufactured object FO (see FIG. 4) and a connection port to which not-shown piping is connected for the supply and discharge of the material M.

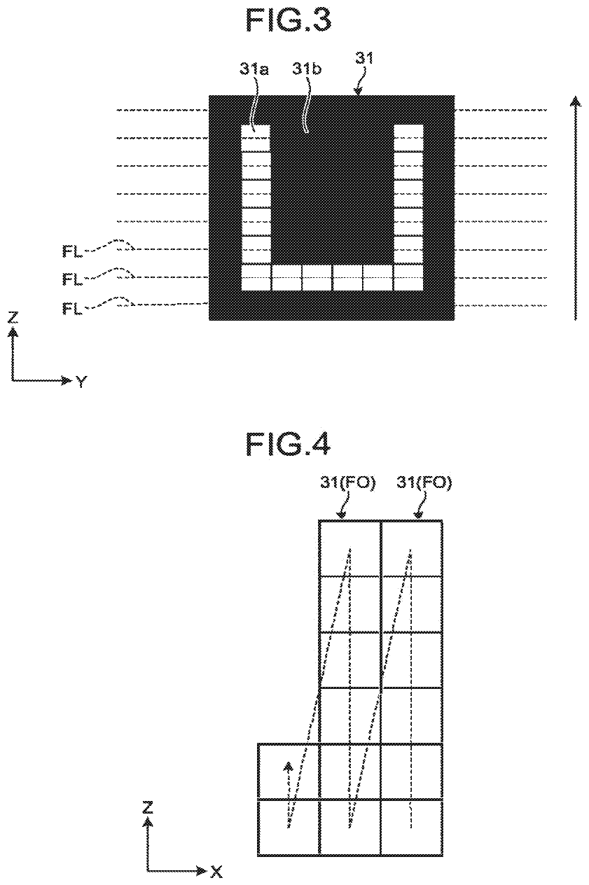

The stereolithography units 10U, 10D emit the lights L1, L2 to respective positions P in the liquid tank 2. As shown in FIG. 2, the lights L, L2 linearly intersect each other at the positions P (target positions). Herein, the light L1 is given (set with) at least two areas 31a, 31b (see FIGS. 2 and 3) having different optical properties (such as phase) by area setters 16 of spatial light modulators 30, as shown in FIG. 1. Optical systems 3 and 4 are configured such that at the intersections between the area 31a of the light L1 and the light L2, constructive interference occurs, increasing energy to cure the material M while at the intersections between the area 31b of the light L1 and the light L2, destructive interference or no constructive interference occurs, not curing the material M. With such configurations and settings, the material-M curable area and non-curable area can be selectively set in the linear positions P. The stereolithography units 10U, 10D move the positions P, for example, stepwise or at a required speed inside the liquid tank 2. Thereby, layers are additively formed on a previously cured layer of the object FO, enlarging the cured object FO sequentially. According to the present embodiment, the positions P or the target positions where the material M is cured extends straight (linearly), for example. Thus, the time taken for manufacturing an intended object can be shortened from when the target positions are point-like. The positions P may be referred to as target lines or target areas. The light L1 is an example of a first light while the light L2 is an example of a second light. The area 31a is an example of a first area and the area 31b is an example of a second area.

The stereolithography units 10U, 10D can include same or like elements and be similarly configured to each other. The stereolithography units 10U, 10D can work for additive manufacturing at the respective positions P concurrently. The positions P of the stereolithography units 10U, 10D inside the liquid tank 2 are different from each other. The locations or moving speeds of the positions P can be individually set in the stereolithography units 10U and 10D.

The stereolithography units 10U, 10D each include a light source 8. The light sources 8 include, for example, optical elements that can emit laser light L (such as ultra-violet laser) capable of curing the photocurable material M. The light sources 8 of the stereolithography units 10U, 10D can emit non-interfering lights with different wavelengths or polarization angles from each other, for example. The laser light L is an example of energy line.

The stereolithography units 10U, 10D both include the optical systems 3, 4. The optical systems 3, 4 may be referred to as assemblies or sub-assemblies of optical elements. The optical systems 3 regulate the light L1 while the optical systems 4 regulate the light L2. The optical systems 3 are an example of a first optical system and the optical systems 4 are an example of a second optical system.

In each of the stereolithography units 10U, 10D, the light source 8 is shared by the optical system 3 and the optical system 4. Specifically, the laser light L from the light source 8 is divided (split) into two light fluxes by an optical splitter 9, one of the light fluxes or the light L1 is incident on the optical system 3 and the other or the light L2 is incident on the optical system 4. The optical splitter 9 can include a polarizing beam splitter or a half mirror, for instance. FIG. 1 shows the example that the optical splitters 9 split the laser light L emitted from the light sources 8 into transmitted light L1 and reflected light L2. Alternatively, the stereolithography units 10U, 10D can include light sources 8 corresponding to the optical systems 3, 4 in place of the optical splitters 9. The light L1 may be reflected light while the light L2 may be transmitted light. The optical splitters 9 may be referred to as optical distributors.

The optical systems 3 each include a half wavelength plate 12 and the spatial light modulator 30, for example, in addition to the light source 8 and the optical splitter 9. The spatial light modulators 30 convert the light L1 into pattern light including a pattern 31 of the area 31a and the area 31b.

The spatial light modulators 30 each include an optical path changer 15, the area setter 16, a half wavelength plate 17 and lenses 18, 19, for example. The optical path changer 15 is, for example, made of a polarizing beam splitter or a half mirror and reflects the light from the half wavelength plate 12 to the area setter 16. The light L1 is reflected by the area setter 16, transmits through the optical path changer 15, and horizontally (X direction) travels through the half wavelength plate 17 and the lenses 18, 19 to be incident on the liquid tank 2. The distance between the lenses 18, 19 is changeable. In accordance with a change in the distance between the lenses 18, 19, the beam diameter of the light L1 can be adjusted, for example.

The area setters 16 can each include a first reflective area which reflects light with no change in phase and a second reflective area which reflects light with a change in phase, both of which are not shown. Switching controllers 5 can variably set the first and second reflective areas of the area setters 16. Part of the light L reflected by the first reflective area turns to the area 31a as shown in FIGS. 2 and 3 and part thereof corresponding to the second reflective area turns to the area 31b as shown in FIGS. 2 and 3. That is, the light L1 is reflected by the area setters 16 to be converted to the pattern light (light including information) including the pattern 31 of the area 31a and the area 31b. The area 31a and the area 31b have different optical properties, for example, differ in phase from each other. The pattern 31 of the area 31a and the area 31b varies at least horizontally (in Y direction). According to the present embodiment, the patterns 31 of the area 31a and the area 31b are formed to vary both horizontally (in Y direction) and vertically (in Z direction), as shown in FIG. 2. For example, the area setters 16 are reflective liquid crystal elements and the switching controllers 5 are controllers that control the reflective liquid crystal elements to switch the first reflective areas and the second reflective areas, in response to an instruction from a not-shown control unit.

The optical systems 4 each include, for example, a prism 11 and a reflector 20 in addition to the light source 8 and the optical splitter 9. The prisms 11 adjust the beam shape of the light L2. Specifically, the prisms 11 convert the beam of the light L2 into a flat beam with a longer horizontal (Y direction) length than a vertical (Z direction) length. The reflectors 20 each include, for example, a mirror 13 and a cylindrical lens 14. The mirrors 13 reflect the light L2 from the prisms 11 to the cylindrical lenses 14. The light L2 horizontally (X direction) traveling is reflected by the mirrors 13 in a vertical direction (Z direction). The cylindrical lenses 14 focus the light L2 from the mirrors 13 on horizontal (Y direction) focal lines FL. The traveling direction of the light L2 can be an intersecting direction with the Z direction, for example, as long as the light L2 forms the horizontal (Y direction) focal lines FL.

FIG. 3 illustrates the pattern 31 including the area 31a and the area 31b of the light L1 for forming one cross section of an intended object FO of a cup shape (see FIG. 4). As described above, the pattern 31 of the area 31a and the area 31b changes horizontally (in Y direction). The optical path lengths of the light L1 and the light L2 from the optical systems 3 and the optical systems 4 are set to cause constructive interference at the positions P. The light L1 and the light L2 are also set to converge on the focal lines FL, reaching necessary intensity for curing the material M, and not to reach the necessary intensity for curing the material M at offset positions from the focal lines FL in the traveling direction of the light L2, i.e., the Z direction in this example. As shown in FIG. 3, thus, at the intersections (in the whitened positions in FIG. 3) of the area 31a and the focal line FL of the light L2, constructive interference occurs, curing the material M to add a layer to the intended object FO. Meanwhile, at the intersections (in the blackened positions in FIG. 3) of the area 31b and the focal line FL of the light L2 and at the offset positions from the focal line FL, destructive interference or no constructive interference occurs, not curing the material M and not adding a layer to the intended object FO. The light L1 can be arbitrary light as long as it has a pattern which varies at least along the focal lines FL (in horizontal direction or Y direction). The traveling direction of the light L1 should not be limited to the X direction and can be in-between the X direction and the Y direction, for example. In the optical systems 3, 4, the optical path length from the light source 8 of the light L1 to the position P and the optical path length from the light source 8 of the light L2 to the position P are adjusted to exert constructive interference at the intersections of the light L1 and the light L2.

According to the present embodiment, as shown in FIG. 1, the cylindrical lenses 14 are configured to be movable (reciprocally movable) vertically (in Z direction) by moving mechanisms 6. The moving mechanisms 6 each include an actuator such as a motor controlled by a not-shown control unit. The moving mechanisms 6 can regulate the vertical (Z direction) positions of the cylindrical lenses 14 to vertically (Z direction) move the positions of the focal lines FL (positions P) stepwise or at a required speed, for example. Thereby, in the cross section of FIG. 3 along the focal line FL (Y direction) and in the vertical direction (Z direction), the position of the focal line FL of the light L2 changes vertically (in Z direction) relative to the light L1 having the two-dimensional pattern 31 of the area 31a and the area 31b.

Further, according to the present embodiment, as shown in FIG. 1, the reflectors 20 are configured to be movable (reciprocally movable) by moving mechanisms 7 horizontally and in the direction (X direction in this example) intersecting (orthogonal to, for example) the focal lines FL. The moving mechanisms 7 each include, for instance, an actuator such as a motor controlled by a not-shown control unit. The moving mechanisms 7 can horizontally (in X direction) move the positions (positions P) of the focal lines FL stepwise or at a required speed, for example, by adjusting the horizontal (X direction) positions of the reflectors 20. As shown in FIG. 4, thus, by the operation of the moving mechanisms 7, the focal lines FL are moved in position horizontally (in X direction) inside the liquid tank 2 and by the operation of the moving mechanisms 6, the focal lines FL are moved in position vertically (in Z direction) inside the liquid tank 2, thereby adding the layers of the cross sectional shape of the intended object FO at each horizontal (X direction) position in sequence. Then, the switching controllers 5 switch the reflective patterns displayed by the area setters 16 upon every change in the horizontal (X direction) positions P, that is, the positions of the reflectors 20 moved by the operation of the moving mechanisms 7. Thereby, the intended object FO can be three-dimensionally manufactured.

According to the present embodiment, as shown in FIG. 1, the stereolithography apparatus 1 includes the stereolithography units 10U, 10D. The stereolithography units 10U, 10D first form the shape of adjacent cross sections along the focal lines FL (in Y direction) and in the moving direction (Z direction) of the moving mechanisms 6 and add the layers of the cross sections to move away from each other in the moving direction (X direction) of the moving mechanisms 7 in order, thereby producing the intended object FO. FIG. 4 illustrates the order of the additive manufacturing of the intended object FO by the stereolithography unit 10U. The order of the additive manufacturing of the intended object FO by the stereolithography unit 10D is horizontally and vertically reverse to that shown in FIG. 4. The stereolithography apparatus 1 can thus manufacture intended objects more quickly by the multiple stereolithography units 10U, 10D. In the two stereoilithography units 10U and 10D the directions (Y direction) of the focal lines FL, the moving directions (Z direction) of the cylindrical lenses 14 by the moving mechanisms 6, and the moving directions (X direction) of the reflectors by the moving mechanisms 7 are set to be parallel to each other. As described above, the light L1 and the light L2 are set not to interfere with each other, so that the stereolithography units 10U, 10D are prevented from obstructing their manufacturing one another.

As described above, the stereolithography apparatus 1 according to the present embodiment is, for example, set to emit the light L1 (first light) and the light L2 (second light) in such a manner that they linearly horizontally (in Y direction or first direction) intersect with each other at the positions P. The light L1 is given the area 31a and the area 31b with different optical properties (such as phase) in the horizontal direction (Y direction or first direction) and exerts the energy from the constructive interference occurring at the intersection of the area 31a and the light L2 to thereby cure the material M. Thus, according to the present embodiment, the intended object FO can be additively manufactured linearly at the positions P, for example, which can shorten the length of time necessary for manufacturing the intended object FO from that for point-like manufacturing.

According to the present embodiment, for example, the optical systems 4 form the focal lines FL in the horizontal direction (Y direction or first direction). The lights L1, L2 are set to form the layers at the positions P where the focal lines FL and the light L1 cross each other. According to the present embodiment, thus, the layers are not added at the offset positions from the focal lines FL. Because of this, the light L1 can be set to have the pattern 31 (areas 31a, 31b) which also varies in the direction crossing the focal lines FL or the moving direction (Z direction or direction crossing first direction) by the moving mechanisms 6, as shown in FIGS. 2 and 3, for instance. Hence, while the positions P (target position) are moved by the moving mechanisms 6, for example, the setting of the pattern 31 (areas 31a, 31b) does not have to be changed. This can make it easier for the switching controller 5 to switch the pattern 31 (areas 31a, 31b).

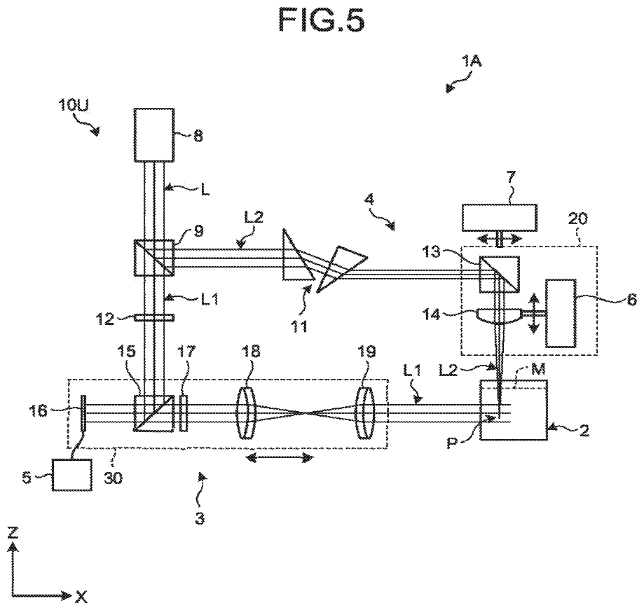

The present embodiment includes, for example, the stereolithography units 10U, 10D each including the optical system 3 (first optical system), the optical system 4 (second optical system), the switching controller 5, and the moving mechanisms 6, 7. Thus, the stereolithography apparatus 1 according to the present embodiment can shorten the length of time taken for manufacturing the intended object FO in comparison with the one including only one stereolithography unit, for example. However, as illustrated in FIG. 5, a stereolithography apparatus 1A including one stereolithography unit 10U can form a linear position P and thereby achieves the effect of reducing the length of time for the manufacturing.

### Second Embodiment

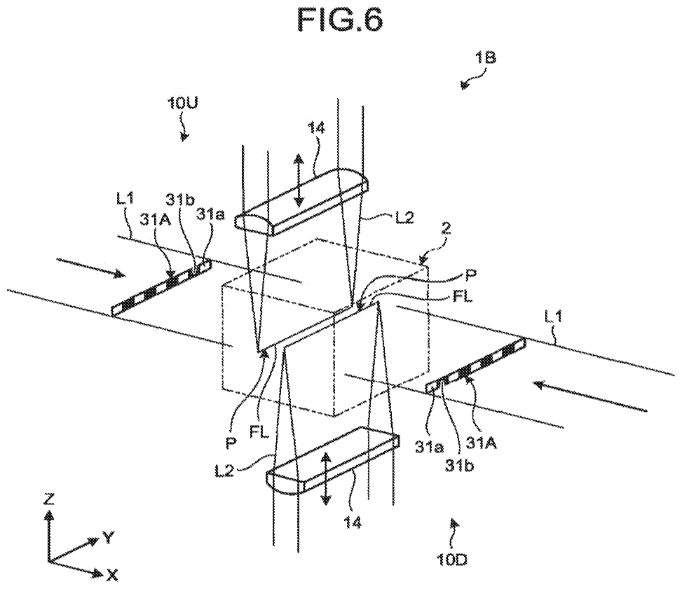

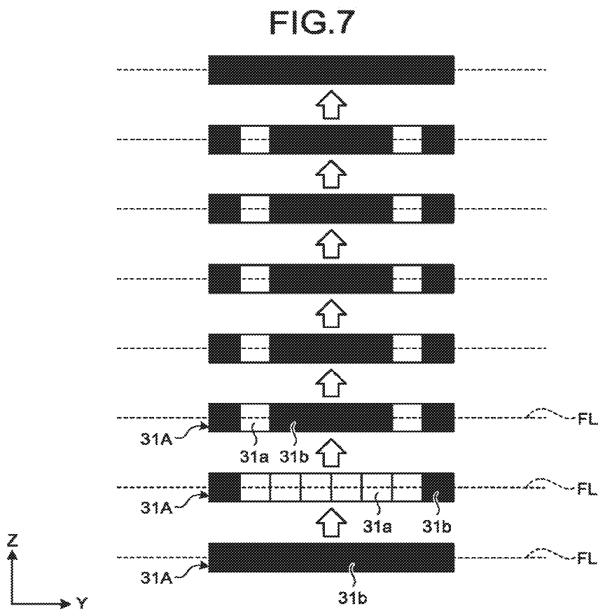

A stereolithography apparatus 1B according to an embodiment as shown in FIGS. 6 and 7 includes substantially the same configuration as the stereolithography apparatus 1 of the first embodiment. The present embodiment can thus attain the same or like results (effects) by the same or like configuration as with the first embodiment.

However, according to the present embodiment, as shown in FIG. 6, for instance, the light L1 from the optical systems 3 (first optical system) is provided linear patterns 31A including areas 31a and areas 31b aligned horizontally (in Y direction or direction of the focal lines FL), instead of the sheet-like patterns 31 in the first embodiment. In the present embodiment the emitted light L1 and the focal line FL of the light L2 are aligned in position vertically (in Z direction). The position of the emitted light L1 can be moved vertically (in Z direction) by changing the output positions of the not-shown reflective patterns by the area setters 16 or moving the reflectors 20 vertically (in Z direction) with not-shown moving mechanisms. The position of the focal line FL of the light L2 is moved vertically (in Z direction) and horizontally (in traveling direction of the light L1 or X direction) in the same manner as in the first embodiment.

FIG. 7 shows the switching of the patterns 31A for manufacturing the intended object FO of a cup shape by way of example. In this case, for instance, in the stereolithography apparatus 18B the patterns 31A are set to move vertically (in Z direction) from one side (downside) to the other side (upside) in the liquid tank 2 along with the motion of the focal lines FL (positions P) and to be switched in accordance with the respective moving positions. In the present embodiment the positions P (target positions) are also set to the positions of the focal lines FL when the light L1 and the light L2 intersect each other. In this case, a cross section of part of the intended object FO similar to that shown in FIGS. 3 and 4 can be layered. The present embodiment can hence attain a manufactured object FO and effects similar to those in the first embodiment.

### Third Embodiment

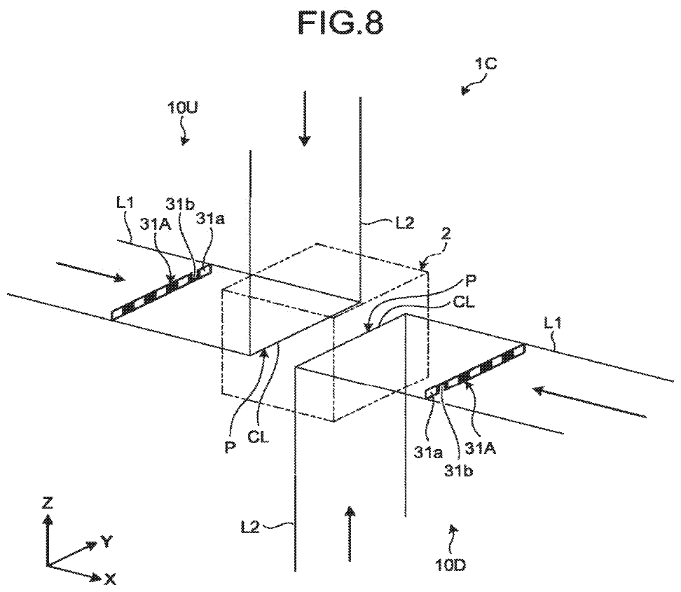

A stereolithography apparatus IC according to an embodiment as shown in FIG. 8 has substantially the same configuration as the stereolithography apparatus 1 in the first embodiment. Thus, the present embodiment can attain the same or like results (effects) by the same or like configuration as those in the first embodiment and the second embodiment.

The present embodiment, however, employs vertical (Z direction) and horizontal (Y direction) sheet-like light (laser light sheet) for the light L2, as shown in FIG. 8, for instance. According to the present embodiment, the light L1 and the light L2 are set to linearly cross each other at the positions P (target positions) to become cross lines CL. Also, in the present embodiment the positions P or the cross lines CL move vertically (in Z direction) along with the movement of the position of the emitted light L1 as in the second embodiment. The positions P are also moved horizontally (in X direction) by horizontally moving the not-shown optical systems 4 for the light L2. According to the present embodiment, the configurations or control of the optical systems or the moving mechanisms may be further simplified.

While certain embodiments have been described, these embodiments have been presented by way of example only, and are not intended to limit the scope of the invention. Indeed, the embodiments described herein can be implemented in a variety of other forms; furthermore, various omissions, substitutions, combinations and changes may be made thereto without departing from the spirit of the invention. The embodiments described herein are embodied in the scope or gist of the invention and in the scope of the invention recited in the accompanying claims and their equivalents. The present invention can be realized by other configurations than the ones disclosed herein and can attain a variety of effects (including derivative effects) by the basic configuration (technical features). The specifications of each constituent element (structure, kind, direction, shape, size, length, width, thickness, height, number, arrangement, position, material, and the like) can be appropriately changed. For instance, areas having different optical properties can be set to the second light or both of the first light and the second light. The optical property can be an attribute other than phase (for example, intensity). Constructive interference curing materials may occur due to any one of multiple areas. The direction of emission or the flux shapes of the first light and the second light can be variously set as long as the first light and the second light form linear target positions with higher intensity than that of the other areas in their crossover areas. For example, the first light and the second light do not need to be orthogonal to each other. The moving mechanisms may move the target positions in various manners such as by moving an object or a liquid tank.

1. A stereolithography method comprising:
emitting a first light to a photocurable material;
emitting a second light to the photocurable material such that a target area is formed in the photocurable material, the target area linearly intersecting the first light in a first direction;
setting a first area and a second area for the first light in the first direction at the target area, the first area and the second area having different optical properties from each other; and
moving the target area, and
curing the photocurable material at the target area, wherein
the second light and the first area of the first light are configured to cause constructive interference at the target area to cure the photocurable material, and
the second light and the second area of the first light are configured to cause no constructive interference at the target area.

2. The stereolithography method according to claim 1, wherein
the second light forms a focal line extending in the first direction, the focal line intersecting with the first light in the target area.

3. The stereolithography method according to claim 1, wherein
the moving includes moving the target area in a direction intersecting the first direction.

4. The stereolithography method according to claim 1, wherein
the first light and the second light have a sheet-like form.

5. The stereolithography method according to claim 1, further comprising
splitting a source light into the first light and the second light.

6. A stereolithography method comprising:
emitting a pattern light into a photocurable material, the pattern light including a first area and a second area at least in a first direction, the first area and the second area having different optical properties;
emitting a second light into the photocurable material such that the second light intersects the pattern light;
moving an intersection between the pattern light and the second light in a direction intersecting the first direction; and
setting a target position and a non-target position in the first direction inside the photocurable material, the target position being a position at which the second light and the first area are configured to cause constructive interference, the non-target position being a position at which the second light and the second area are configured to cause no constructive interference.
